(19) United States
(12) Patent Application Publication
(10) Pub. No.: US 2015/0062613 A1
(43) Pub. Date: Mar. 5, 2015

(54) IMAGE FORMING APPARATUS CAPABLE OF PREVENTING DATA LEAKAGE AND CONTROL METHOD THEREFOR, AND STORAGE MEDIUM

(71) Applicant: CANON KABUSHIKI KAISHA, Tokyo (JP)

(72) Inventor: Hidenori HIGASHI, Kawasaki-shi (JP)

(21) Appl. No.: 14/467,519

(22) Filed: Aug. 25, 2014

(30) Foreign Application Priority Data
Aug. 27, 2013 (JP) 2013-175574

(51) Int. Cl. G06K 15/00; H04N 1/00; H04N 1/21

(52) U.S. Cl. CPC G06K 15/409; G06K 15/002; H04N 1/21; H04N 1/00899; H04N 2201/0094; H04N 2201/21
USPC 358/1.14

(57) ABSTRACT

There is provided an image forming apparatus capable of preventing leakage of data held in a nonvolatile main storage memory by a malicious program or the like even if a shutdown process was not normally performed last time. If it is judged, when the image forming apparatus is started, that the shutdown process was not normally performed last time, a whole or a partial area of the main storage memory is refreshed before starting the information forming apparatus.

### BACKGROUND OF THE INVENTION

1. Field of the Invention

The present invention relates to an image forming apparatus and a control method therefor, and a storage medium, and more particularly, to an image forming apparatus capable of preventing leakage of data held on a nonvolatile main storage memory even if a normal shutdown process cannot be performed, and a control method therefor, and a storage medium.

2. Description of the Related Art

Conventionally, a volatile memory such as a DRAM has been used for a main storage memory of an information processing apparatus from viewpoints of access speed, storage capacity, reliability and the like. However, content stored in the volatile memory disappears when power is cut off. Therefore, an image forming apparatus provided with a volatile main storage memory is adapted to load a program and data stored in an auxiliary storage device on the main storage memory when the apparatus is powered on. Therefore, it takes much time to start the apparatus.

Recently, an image forming apparatus provided with a nonvolatile main storage memory has been put to practical use. In such an image forming apparatus, it is possible to continue holding data in the main storage memory even when power is cut off. Therefore, it is not necessary to load a program and data stored in an auxiliary storage device on the main storage memory each time power is turned on, and it is possible to start the image forming apparatus in a short time.

In general, an image forming apparatus ends its operation in response to a shutdown request and executes a shutdown process for powering off the apparatus, by software. However, it may happen that the apparatus is suddenly powered off due to power failure, tear of a power cable, or unintentional removal of a power cable plug from a socket. In this case, the shutdown process is not normally executed. There is also a possibility that the software hangs up during execution of the shutdown process. In such a case, generally, power is forcedly cut off by the hardware after elapse of a predetermined time. That is, the shutdown process by the software is not normally executed.

If the shutdown process cannot be normally performed in an image forming apparatus provided with a nonvolatile main storage memory, the image forming apparatus is started next time in a state in which data before the power cutoff is scattered on the main storage memory. In this case, there is a possibility that, if a malicious program is executed, the data on the main storage memory is leaked.

In the image forming apparatus disclosed in Japanese Laid-Open Patent Publication (Kokai) No. 2003-150360, confidential data left on a main storage memory is erased at the time of restart, and the confidential data is erased when an unauthorized operation is performed. Thereby, it is possible to prevent unauthorized acquisition of the data and enhance security. According to this image forming apparatus, however, it is necessary to judge whether data on the main storage memory is confidential data or not, and the process is complicated. Furthermore, if a shutdown process cannot foe normally performed, for example, due to power failure, the data on the main storage memory is held in a state before the power failure, and there is a possibility that the data is leaked.

### SUMMARY OF THE INVENTION

The present invention provides an image forming apparatus capable of preventing leakage of data held in a nonvolatile main storage memory by a malicious program or the like even if a shutdown process was not normally performed last, time and provides a control method for the image forming apparatus and a storage medium in which a program for executing the control method is stored.

According, a first, aspect of the present invention provides an image forming apparatus an image forming apparatus provided with a nonvolatile main storage device, comprising a judgment unit configured to, when the information forming apparatus is started, judge whether the last shutdown process was normally performed, and a control unit configured to, if it is judged by said judgment unit that the last shutdown process was not normally performed, refresh a whole or a part of an area of the main storage device before starting the information forming apparatus.

Accordingly, a second aspect of the present invention provides an image forming apparatus provided with a nonvolatile main storage device and a user interface configured to accept a setting by a user, comprising a judgment unit configured to, when the image forming apparatus is started, judge whether a predetermined user setting has been made or not via the user interface, and a control unit configured to, if it is judged by said judgment unit that the predetermined user setting has been made, refresh a whole or a part of an area of the main storage device before starting the information forming apparatus.

Accordingly, a third aspect of the present invention provides a control method for an image forming apparatus provided with a nonvolatile, main storage device, comprising a judgment step of, when the information forming apparatus is started, judging whether the last shutdown process was normally performed, and a control step of, if it is judged in said judgment step that the last shutdown process was not normally performed, refresh a whole or a part of an area of the main storage device before starting the information forming apparatus.

Accordingly, a fourth aspect of the present invention provides a control method for an image forming apparatus provided with a nonvolatile main storage device and a user interface configured to accept a setting by a user, comprising a judgment step of, when the image forming apparatus is started, judging whether a predetermined user setting has been made or not via the user interface, and a control step of, if it is judged in said judgment step that the predetermined user setting has been made, refreshing a whole or a part of an area of the main storage device before starting the information forming apparatus.

Accordingly, a fifth aspect of the present invention provides a non-transitory computer-readable storage medium storing a program for causing a computer to implement a control method for an image forming apparatus provided with a nonvolatile main storage device, the control method comprising a judgment step of, when the information forming apparatus is started, judging whether the last shutdown process was normally performed, and a control step of, if it is judged in said judgment step that the last shutdown process was not normally performed, refreshing a whole or a part of an area of the main storage device before starting the information forming apparatus.

Accordingly, a sixth aspect of the present invention provides a non-transitory computer-readable storage medium storing a program for causing a computer to implement a control method for an image forming apparatus provided with a nonvolatile main storage device and a user interface configured to accept a setting by a user, the control method comprising a judgment step of, when the image forming apparatus is started, judging whether a predetermined user setting has been made or not via the user interface, and a control step of, if it is judged in said judgment step that the predetermined user setting has been made, refreshing a whole or a part of an area of the main storage device before starting the information forming apparatus.

According to the present invention, it is possible to, even if the shutdown process was not normally performed in the image forming apparatus provided with the nonvolatile main storage memory, prevent leakage of data held in the main storage memory.

Further features of the present invention will become apparent from the following description of exemplary embodiments (with reference to the attached drawings).

### BRIEF DESCRIPTION OF THE DRAWINGS

FIG. 1 is a block diagram showing a schematic configuration of an image forming apparatus according to a first embodiment of the present invention.

FIG. 2 is a block diagram showing a schematic configuration of a controller of the image forming apparatus.

FIG. 3 is a flowchart showing a flow of start and end processes in the image forming apparatus.

FIG. 4 is a flowchart showing a flow of start and end processes in an image forming apparatus according to a second embodiment of the present invention.

### DESCRIPTION OF THE EMBODIMENTS

Embodiments of the present invention will now be described below in detail with reference to the drawings.

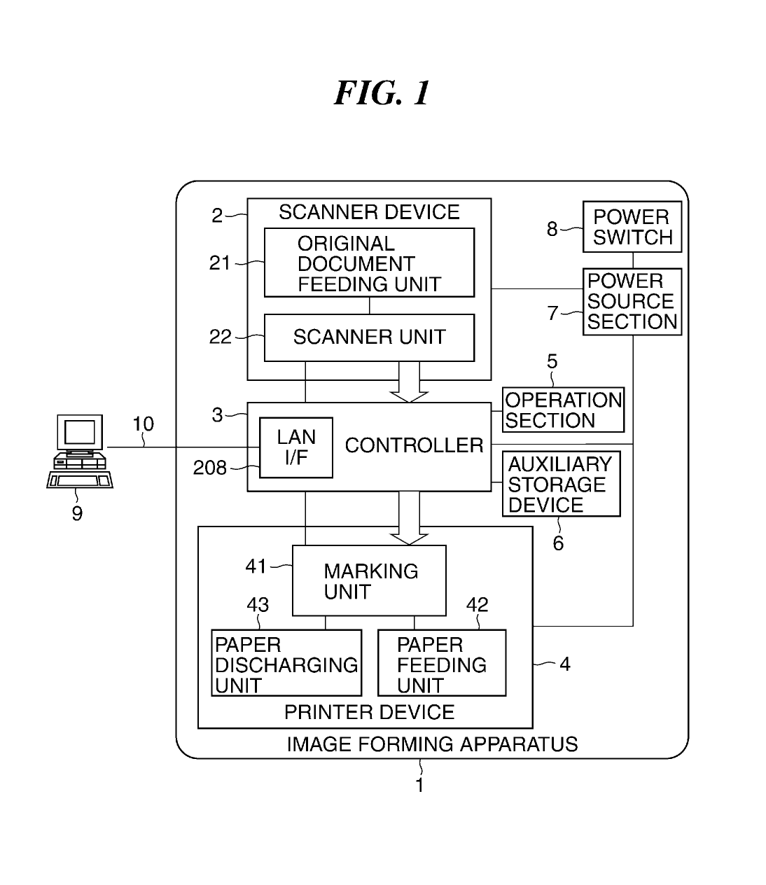

FIG. 1 is a block diagram showing a schematic configuration of an image forming apparatus according to a first embodiment of the present invention.

In FIG. 1, an image forming apparatus 1 is provided with a scanner device 2 which optically reads an image from an original document. The scanner device 2 has an original document feeding unit 21 which feeds an original document from a bundle of original documents and a scanner unit 22 which optically scans the original document to obtain a digital image.

A printer device 4 prints and outputs a digital image on a paper medium. The printer device 4 has a paper feeding unit 42 for feeding paper sheets from a bundle of paper sheets one by one, a marking unit 41 for printing images on the fed paper sheets, and a paper discharging unit 43 for discharging the paper sheets on which the images are printed.

An operation section 5 is provided with various keys and buttons (not shown) for operating the image forming apparatus 1, and a display section for displaying setting information about the image forming apparatus 1 and job information. An auxiliary storage device 6 is constituted by a hard disk drive (HDD) or the like and stores digital images, a control program and the like. A power source section 7 is connected to a power source (not shown) via a power switch 3 and supplies power to the scanner device 2, the printer device 4 and a controller 3.

The controller 3 is connected to each of the above sections of the apparatus and can execute a job by giving an instruction to each section of the apparatus. The controller 3 has a LAN I/F 208 connected to a LAN 10 can input and output a digital image to and from an external computer 9 via the LAN 10 and can issue or specify a job.

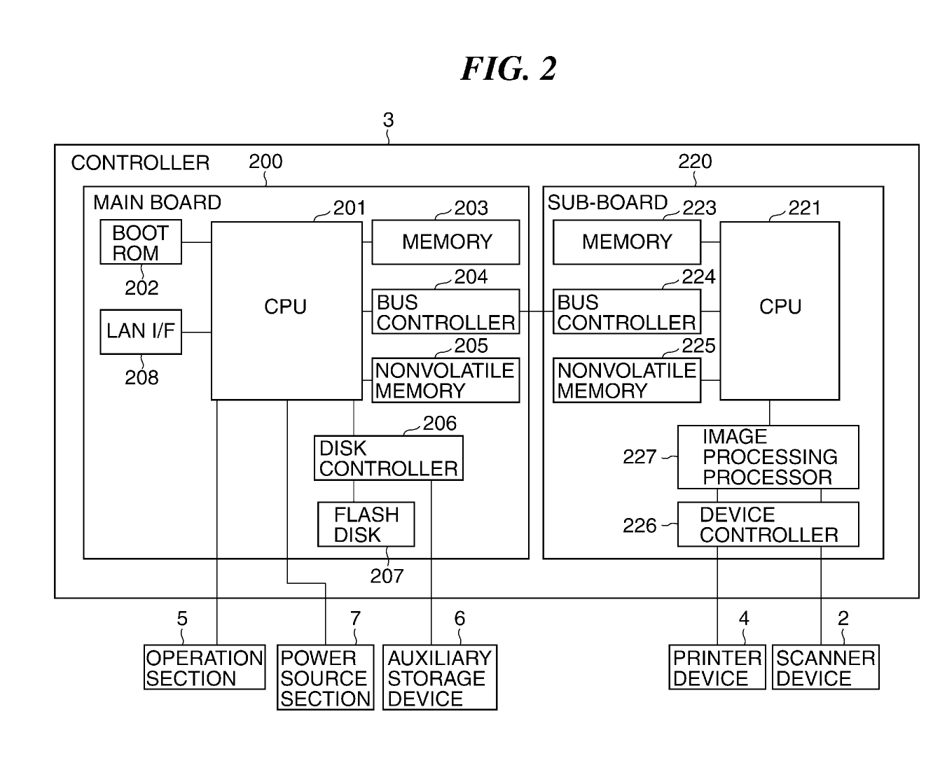

FIG. 2 is a block diagram showing a schematic configuration of the controller 3.

The controller 3 is constituted by a main board 200 and a sub-board 220.

The main board 200 is a so-called general-purpose CPU system, is connected to the operation section 5, the auxiliary storage device 6 and the power source section 7 via an interface not shown, and is constituted by devices described below.

A CPU 201 controls the whole main board. A boot ROM 202 stores a boot program. A memory 203 is a nonvolatile main storage memory constituted by a magnetoresistive random access memory (hereinafter referred to as an MRAM) or the like and is used as a work memory of the CPU 201.

A bus controller 204 has a function of a bridge to an external bus. A nonvolatile memory 205 can hold data even if power is cut off. A disk controller 206 controls the auxiliary storage device 6 and a flash disk 207. The flash disk 207 is a relatively small capacity storage device, which is constituted by a semiconductor device such as an SSD, The LAN I/F 208 is an interface for performing network connection to the outside and is connected to the LAN 10 as already described.

The sub-board 220 is provided with a relatively small general-purpose CPU system and image processing hardware and is constituted by devices described below.

A CPU 221 controls the whole sub-board. A memory 223 is a nonvolatile main storage memory constituted by an MRAM or the like and is used as a work memory of the CPU 221. A bus controller 224 has a function of a bridge to an external bus. A nonvolatile memory 225 can hold data even if power is cut off. An image processing processor 227 performs digital image processing in real time. A device controller 226 is connected to the printer device 4 and the scanner device 2 to control them.

It should be noted that, though a chip set, a bus bridge, a clock generator and the like are connected to or included in each of the CPUs 201 and 221, they are not shown, and description thereof will be omitted. The configurations of the main board 200 and the sub-board 220 are not limited to those shown in FIG. 2.

Next, an operation of the controller 3 will be described, with the case of copying an image on a paper medium as an example.

When a user specifies image copying from the operation section 5, the CPU 201 of the main board 200 sends an image read command to the scanner device 2 via the CPU 221 of the sub-board 220, The scanner device 2 transmits digital image data obtained by optically scanning a paper document to the image processing processor 227 via the device controller 226. The image processing processor 227 transfers the digital image data transmitted from the scanner device 2 to the memory 223 via the CPU 221. Otherwise, the image processing processor 227 performs DMA transfer of the digital image data to the memory 223 to temporarily store the digital image data in the memory 223.

When all or a predetermined amount of the digital image data is temporarily stored in the memory 223, the CPU 201 gives an image output instruction to the printer device 4 via the CPU 221. The CPU 221 notifies the image processing processor 227 of a storage position of the image data in the memory 223. The image data temporarily stored in the memory 223 is transmitted to the printer device 4 via the image processing processor 227 and the device controller 226 in accordance with a synchronization signal from the printer device 4 and printed on a paper medium at the printer device 4.

In the case of multiple copy printing, the CPU 201 causes the image data temporarily stored in the memory 223 to foe stored into the auxiliary storage device 6. At the time of the second and subsequent printing, the image data can he read out from the auxiliary storage device 6 and transmitted to the printer device 4.

A DRAM (dynamic RAM) has been mainly used for a main storage memory (work memory) of an information processing apparatus such as an image forming apparatus for a long time from viewpoints of access speed, storage capacity, reliability and the like. However, when the apparatus is powered off, all data held in the DRAM, which is a work memory, disappears. On the other hand, a nonvolatile memory such as a flash memory has not been used as a work memory from viewpoints of access speed, reliability (restriction on the number of times of rewriting) and the area of memory cell.

Recently, an MRAM has been put to practical use as a memory LSI which solves the problems of access speed, reliability (restriction on the number of times of rewriting) and the area of memory cell. In the case of an apparatus provided with a main memory constituted by an MRAM, data is held in the main memory even if power is turned off. Therefore, a process for loading a program and the data to the main memory from an auxiliary storage device 6 or the like when power is turned on next time becomes unnecessary, and time for starting the apparatus can be reduced.

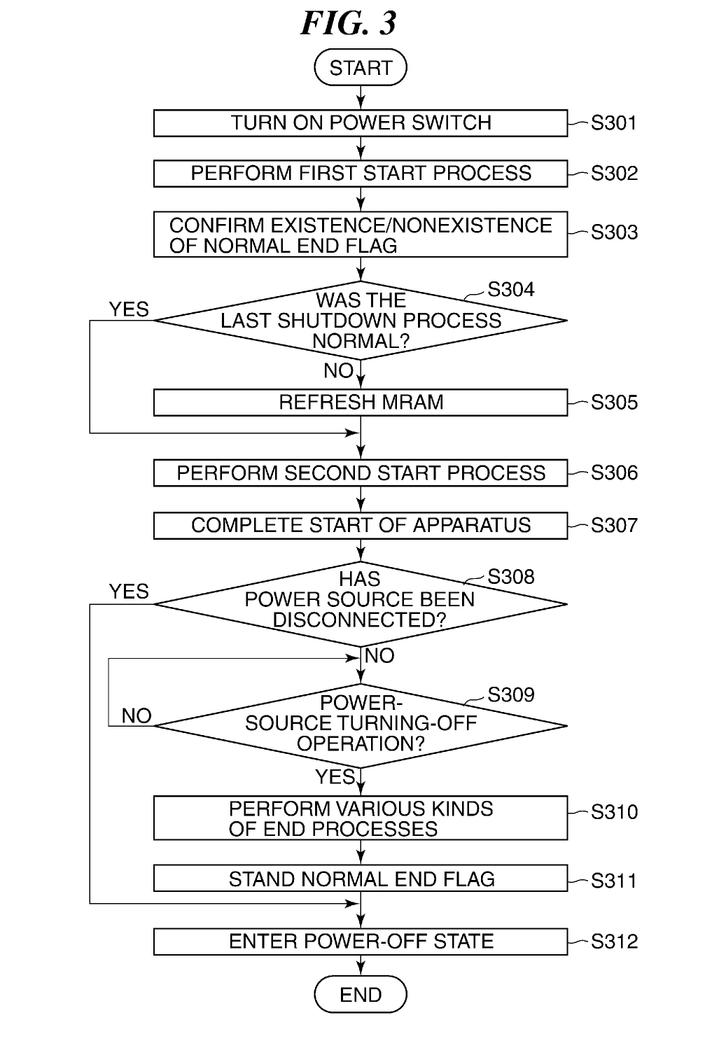

FIG. 3 is a flowchart showing a flow of start and end processes in the image forming apparatus 1.

When the power switch 8 of the image forming apparatus 1 is turned on, and power is supplied to the controller 3 from the power source section 7 (step S301), a first start process (initial setting) is performed by a start program stored in the boot ROM 202 of the controller 3 (step S302), and, thereby, the CPUs 201 and 221 can access the main storage memories 203 and 223, respectively. Next, the CPUs 201 and 221 confirm existence/nonexistence of a normal end flag held in the memories 203 and 223, respectively (step S303) and judges whether the last shutdown process was normally performed or not (step S304).

If judging that the last shutdown process was not normally performed (step S304: NO), the CPUs 201 and 221 refresh (rewrite) the content of the memories 203 and 223, which are MRAMs (step S305), and proceed to step S306.

In step S305, only a heap area or the whole area of each MRAM can be refreshed. In the case of refreshing only the heap area, the process for loading the program from the auxiliary storage device 6 or the like becomes unnecessary, and the time required for start is reduced in comparison with the case of refreshing the whole area of each MRAM.

If it is judged that the last shutdown was normally performed (step S304: YES), a second start process is performed without refreshing the MRAMs (step S306). Thereby, initial settings are made in a state in which the memories 203 and 223 are accessible.

It should be noted that the process from steps S301 to S306 is executed by the start program stored in the boot ROM 202, and the process in and after step S307 is executed by an OS or an application.

Start of the image forming apparatus 1 is completed (step S307), and the image forming apparatus 1 becomes possible to accept various inputs. Next, it is determined whether the power source has been disconnected or not (step S308). If the power source has not been disconnected (step S308: NO), the CPU 201 monitors a power-source turning-off operation by the user (step S309).

If it is judged that the power-source turning-off operation has been performed (step S309: YES), various kinds of end processes are performed (step S310). In the various kinds of end processes, an end process for the memories 203 and 223 is performed. Thereby, for example, important data which should be prevented from being leaked is cleared, and the shutdown process and the like are performed. Then, a normal end flag meaning that the shutdown process has been normally performed stands (step S311), and the image forming apparatus 1 enters a power-off state (step S312).

On the other hand, if the power source is suddenly disconnected because of power failure or the like after the image forming apparatus 1 is started (step S308: YES), the image forming apparatus 1 enters the power-off state without the shutdown process being normally performed (step S312).

According to the first embodiment described above, if it is judged, when the image forming apparatus 1 is started, that the last shutdown process was not normally performed, the image forming apparatus 1 is started after the whole or a part of the area of each of the main storage memories 203 and 223 is refreshed. Thus, even if an image forming apparatus provided with nonvolatile main storage memories was not normally shut down last time, leakage of confidential data and the like held in the main storage memories can be prevented.

An image forming apparatus according to a second embodiment of the present invention has the same configurations as those of the above first embodiment shown in FIGS. 1 and 2. Therefore, description thereof will be omitted. Only points different from the above first embodiment will be described below.

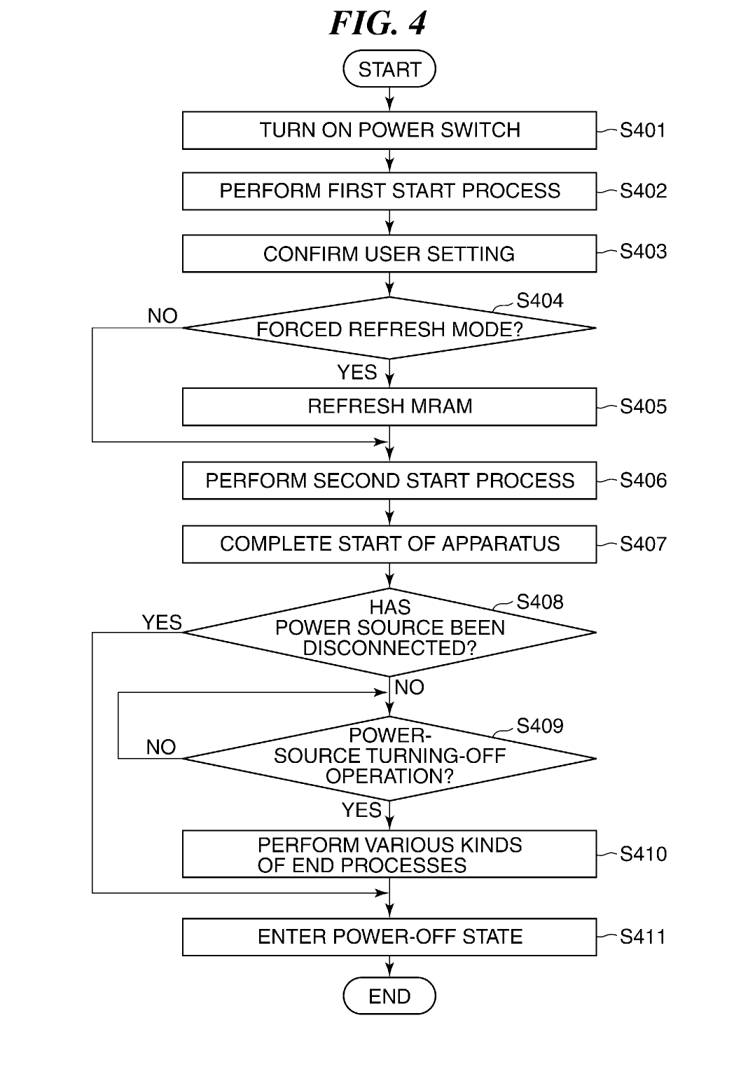

FIG. 4 is a flowchart showing a flow of start and end processes in the image forming apparatus according to the second embodiment of the present invention.

When the power switch 8 of the image forming apparatus 1 is turned on, and power is supplied to the controller 3 from the power source section 7 (step S401), a first start process similar to the process performed in step S302 in FIG. 3 is performed (step S402). Next, a setting made by the user is confirmed (step S403), and it is judged whether a forced refresh mode is set or not (step S404). The user can set the forced refresh mode (predetermined user setting) by operating the operation section 5 which is a user interface for accepting a user setting.

If the forced refresh mode is set (step S404: YES), the CPUs 201 and 221 refresh the content of the memories 203 and 223, which are MRAMs (step S405), and proceed to step S406. In step S405, the whole area of each of the MRAMs is refreshed, or a partial area of each of the MRAMs is refreshed. In the case of refreshing partial areas of the MRAMs, the time required for start is reduced as already described.

If the forced refresh mode is not set (step S404: NO), a second process similar to the process performed in step S306 in FIG. 3 is performed (step S406).

It is also possible to perform the confirmation of the normal end flag in step S303 in FIG. 3 before the second start process is executed and, if the last shutdown process was not normally performed, perform the refreshment of the MRAMs in step S305 in FIG. 3, although not shown in FIG. 4.

It should be noted that the process from steps S401 to S406 is executed by the start program stored in the boot ROM 202, and the process in and after step S407 is executed by an OS or an application.

In step S407, start of the image forming apparatus 1 is completed, and the image forming apparatus 1 becomes possible to accept various inputs. Next, it is determined whether the power source has been disconnected or not (step S408). If the power source has not been disconnected (step S403: NO), the CPU 201 monitors a power-source turning-off operation by the user (step S409). If it is judged that the power-source turning-off operation has been performed (step S409: YES), various end processes, including the shutdown process, similar to the processes performed in step S310 in FIG. 3 are performed (step S410), and the image forming apparatus 1 enters the power-off state (step S411).

On the other hand, if the power source is suddenly disconnected after the image forming apparatus 1 is started, the image forming apparatus 1 enters the power-off state without the shutdown process being normally performed (step S411).

According to the second embodiment, if it is judged, when the image forming apparatus 1 is started, that the image forming apparatus 1 is in a mode of starting the image forming apparatus 1 after refreshing the main storage devices, the image forming apparatus 1 is started after the whole area or a partial area of each of the memories 203 and 223 serving as the main storage device is refreshed. Thus, even if the shutdown process was not normally performed last time in an image forming apparatus provided with nonvolatile main storage devices, leakage of confidential data and the like held in the main storage devices can be prevented. Furthermore, by providing such a mode that the image forming apparatus 1 is started after all the content of the main storage devices is cleared irrespective of whether the shutdown process normally ended or abnormally ended last time, the image forming apparatus can be used in an environment requiring high security.

Though existence/nonexistence of a power-source turning-off operation by the user is judged in step S309 in FIG. 3 and step S409 in FIG. 4 in the above first and second embodiments, it is also possible to judge whether a power-off request by a timer or a power-off request via a network has been received or not.

### Other Embodiments

Embodiments of the present invention can also be realized by a computer of a system or apparatus that, reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-175574, filed Aug. 27, 2013, which is hereby incorporated by reference herein in its entirety.

1. An image forming apparatus provided with a nonvolatile main storage device, comprising:
a judgment unit configured to, when the image forming apparatus is started, judge whether the last shutdown process was normally performed; and
a control unit configured to, if it is judged by said judgment unit that the last shutdown process was not normally performed, refresh a whole or a part of an area of the main storage device before starting the image forming apparatus.

2. The image forming apparatus according to claim 1, wherein the main storage device includes a magnetoresistive random access memory.

3. An image forming apparatus provided with a nonvolatile main storage device and a user interface configured to accept a setting by a user, comprising:
a judgment unit configured to, when the image forming apparatus is started, judge whether a predetermined user setting has been made or not via the user interface; and
a control unit configured to, if it is judged by said judgment unit that the predetermined user setting has been made, refresh a whole or a part of an area of the main storage device before starting the image forming apparatus.

4. The image forming apparatus according to claim 3, wherein the main storage device includes a magnetoresistive random access memory.

5. A control method for an image forming apparatus provided with a nonvolatile main storage device, comprising:
a judgment step of, when the image forming apparatus is started, judging whether the last shutdown process was normally performed; and
a control step of, if it is judged in said judgment step that the last shutdown process was not normally performed, refresh a whole or a part of an area of the main storage device before starting the image forming apparatus.

6. A control method for an image forming apparatus provided with a nonvolatile main storage device and a user interface configured to accept a setting by a user, comprising:
a judgment step of, when the image forming apparatus is started, judging whether a predetermined user setting has been made or not via the user interface; and
a control step of, if it is judged in said judgment step that the predetermined user setting has been made, refreshing a whole or a part of an area of the main storage device before starting the information image forming apparatus.

7. A non-transitory computer-readable storage medium storing a program for causing a computer to implement a control method for an image forming apparatus provided with a nonvolatile main storage device, the control method comprising:
a judgment step of, when the image forming apparatus is started, judging whether the last shutdown process was normally performed; and
a control step of, if it is judged in said judgment step that the last shutdown process was not normally performed, refreshing a whole or a part of an area of the main storage device before starting the image forming apparatus.

8. A non-transitory computer-readable storage medium storing a program for causing a computer to implement a control method for an image forming apparatus provided with a nonvolatile main storage device and a user interface configured to accept a setting by a user, the control method comprising:
a judgment step of, when the image forming apparatus is started, judging whether a predetermined user setting has been made or not via the user interface; and
a control step of, if it is judged in said judgment step that the predetermined user setting has been made, refreshing a whole or a part of an area of the main storage device before starting the information image forming apparatus.
